(19) United States
(12) Patent Application Publication
(10) Pub. No.: US 2025/0346143 A1
(43) Pub. Date: Nov. 13, 2025

(54) SYSTEMS AND METHODS TO IDENTIFY A SUBOPTIMAL CHARGER AND PERFORM REMEDIAL ACTIONS

(71) Applicant: Ford Global Technologies, LLC, Dearborn, MI (US)

(72) Inventors: Dominique Meroux, Ann Arbor, MI (US); Kai Wu, Pittsburgh, PA (US); Ruoxi Wen, Indianapolis, IN (US); Chen Zhang, South Lyon, MI (US); Hyongju Park, Ann Arbor, MI (US)

(73) Assignee: Ford Global Technologies, LLC, Dearborn, MI (US)

(21) Appl. No.: 18/658,044

(22) Filed: May 8, 2024

(51) Int. Cl. B60L 53/63; B60L 53/62; B60L 53/66; B60R 1/22; H04W 4/46

(52) U.S. Cl. CPC B60L 53/63; B60L 53/62; B60L 53/66; B60R 1/22; H04W 4/46; B60L 2240/70; B60R 2300/301

(57) ABSTRACT

A vehicle including a sensor unit and a processor is disclosed. The sensor unit may be configured to capture inputs associated with a charging station when the vehicle may be located at the charging station. The processor may be configured to obtain the inputs from the sensor unit, and determine that the charging station is in a suboptimal condition based on the inputs. The processor may further classify the suboptimal condition into a predefined type, of a plurality of predefined types, based on the inputs, and perform a remedial action based on the predefined type.

### FIELD

The present disclosure relates to systems and methods to identify a suboptimal charger and perform remedial actions based on a type of condition associated with the charger.

### BACKGROUND

Electric Vehicles (EVs) may be charged at EV charging stations. Vehicle owners typically drive to the EV charging stations to get their EVs charged. A vehicle owner may experience inconvenience when the owner drives to an EV charging station and finds the charging station to be in a suboptimal condition. In such situations, the owner may drive to another charging station.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a system to identify a suboptimal charging station and perform remedial actions in accordance with the present disclosure.

FIG. 3 depicts a view of an example first type of suboptimal condition associated with a charging station in accordance with the present disclosure.

FIG. 4 depicts a view of an example second type of suboptimal condition associated with a charging station in accordance with the present disclosure.

FIG. 5 depicts a view of an example third type of suboptimal condition associated with a charging station in accordance with the present disclosure.

FIG. 6 depicts a flow diagram of a method to identify a suboptimal charging station and perform remedial actions in accordance with the present disclosure.

### DETAILED DESCRIPTION

### Overview

The present disclosure describes a vehicle (“first vehicle”) that may be configured to perform a remedial action when a charging station at which the first vehicle may be located may be in a suboptimal condition or the charging station chargers may not be available/accessible for charging. The first vehicle may be configured to determine that the charging station may be in a suboptimal condition based on inputs/images obtained from a vehicle sensor unit. Responsive to determining that the charging station may be in a suboptimal condition, the first vehicle may classify the suboptimal condition into a predefined type, of a plurality of predefined types, based on the inputs/images obtained from the vehicle sensor unit. The first vehicle may then perform remedial action(s) based on the determined predefined type, so that at least one charger becomes accessible to the first vehicle for charging and/or the charging station operator is informed about the charging station's suboptimal condition.

In an exemplary aspect, the first vehicle may determine that the suboptimal condition may be of a first predefined type when all the chargers at the charging station may be occupied, and thus not immediately available for charging. Further, the first vehicle may determine that the suboptimal condition may be of a second predefined type when a second vehicle may be parked at a charger, but may not be getting charged or may already be charged up to a predefined state of charge (SOC) level. Furthermore, the first vehicle may determine that the suboptimal condition may be of a third predefined type when a tire of a third vehicle may be parked on a charging cord of a charger. Additionally, the first vehicle may determine that the suboptimal condition may be of a fourth predefined type when one or more chargers may not be operational or accessible (e.g., be taped off, out of service, unavailable, blocked and/or broken, and/or the like).

In an exemplary aspect, responsive to determining that the suboptimal condition is of first and second predefined types, the first vehicle may transmit a request to the second vehicle's owner, requesting the owner to authorize/cause autonomous movement of the second vehicle, so that the second vehicle may move to a different parking spot in the charging station. When the second vehicle moves to a different parking spot, the charger at which the second vehicle was previously parked becomes available for the first vehicle to charge.

In another exemplary aspect, responsive to determining that the suboptimal condition is of first and fourth predefined types, the first vehicle may transmit an error notification to a server or a computing system associated with a firm that manages charging station operation. The firm may rectify the issue associated with the charger(s) identified by the first vehicle (e.g., the firm may clear snow, debris, etc. that may be blocking the charger), thereby enabling the first vehicle to charge at the charger.

In further aspects, the first vehicle may be configured to output recommendations of different charging stations for the first vehicle owner on the first vehicle's route, when all the chargers at the charging station may be occupied, and the remedial actions described above do not yield an “available” charger for the first vehicle within a predefined short time duration.

In yet another exemplary aspect, responsive to determining that the suboptimal condition is of third predefined type, the first vehicle may transmit a small vehicle movement request to the third vehicle or the third vehicle's owner, causing a short autonomous movement of the third vehicle such that the tire associated with the third vehicle may move away from the charging cord. In this manner, the first vehicle may prevent any potential (future) adverse situation associated with the charging cord.

In some aspects, the first vehicle may request the first vehicle owner to approve/confirm the suboptimal condition type determined by the first vehicle, before the first vehicle performs the remedial actions described above. In further aspects, the first vehicle may be configured to generate a charging station review text by using generative Artificial Intelligence (AI) based on the images/inputs obtained by the vehicle sensor unit and other parameters including user preferences, issues identified at the charging station, and/or the like and post the generated charging station review text on a server or cloud after receiving an approval/confirmation from the first vehicle owner.

The present disclosure discloses a vehicle that is configured to determine whether the charging station may be in a suboptimal condition and perform remedial actions based on a suboptimal condition type. Since the remedial actions are based on the suboptimal condition type, the remedial actions are highly effective and relevant to the determined suboptimal condition. Further, the vehicle performs the remedial actions autonomously and requires minimal user involvement, thereby significantly enhancing user convenience.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

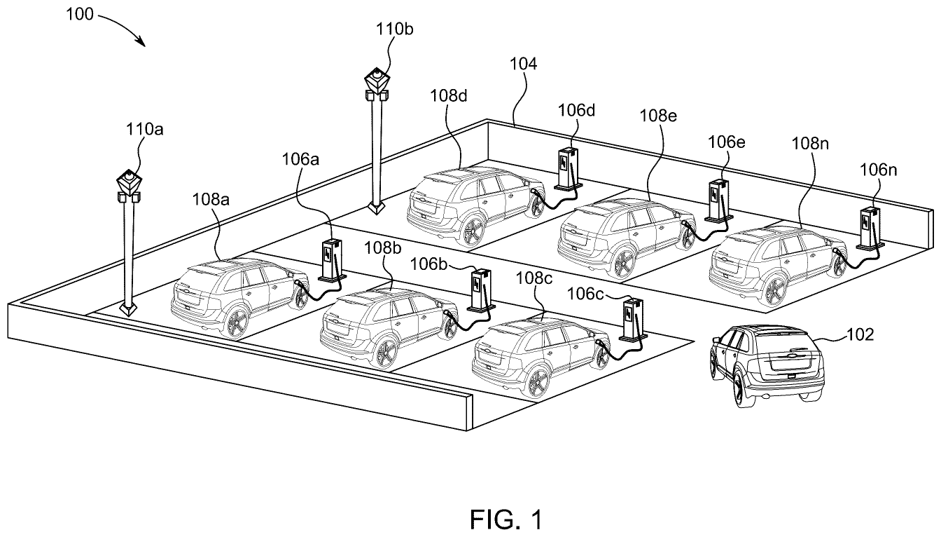

FIG. 1 depicts an example environment 100 in which techniques and structures for providing the systems and methods disclosed herein may be implemented. The environment 100 may include a vehicle 102 that may be traveling in proximity to a charging station 104 or located at the charging station 104. The vehicle 102 may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode. In an exemplary aspect, the vehicle 102 may be an Electric Vehicle (EV) and the charging station 104 may be an EV charging station, although the present disclosure is not limited to such an aspect.

The charging station 104 may include a plurality of chargers 106a, 106b, 106c, 106d, 106e, 106n (collectively referred to as chargers 106) that may enable a plurality of vehicles 108a, 108b, 108c, 108d, 108e, 108n (collectively referred to as vehicles 108, which may be similar to or different from the vehicle 102) to get charged.

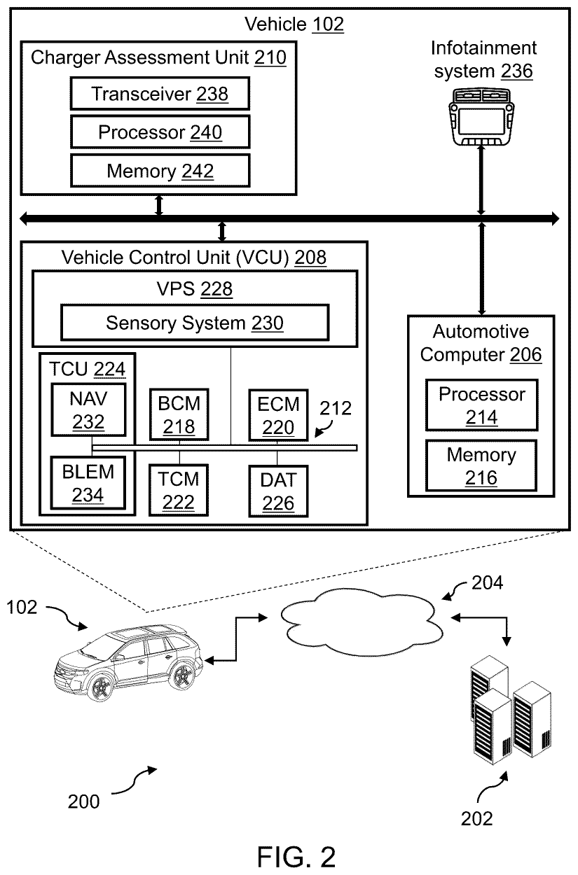

In some aspects, the vehicle 102 may be configured to determine that the charging station 104 may be in a suboptimal condition based on inputs obtained from a vehicle sensor suit (shown as vehicle sensory system 230 in FIG. 2) and/or one or more infrastructure sensors 110a, 110b disposed at the charging station 104, when the vehicle 102 enters the charging station 104, is located at the charging station 104 or is being driven in proximity to the charging station 104. The vehicle 102 may determine that the charging station 104 may be in a suboptimal condition when the vehicle 102 may not be able to charge at the charging station 104 and/or when the vehicle owner associated with the vehicle 102 may not desire to get the vehicle 102 charged at the charging station 104 (due to the charging station's condition). In an exemplary aspect, the vehicle 102 may determine that the charging station 104 may be in a suboptimal condition when, for example, all the chargers 106 may be occupied (as shown in FIG. 1), one or more vehicles 108 may be parked in proximity to one or more chargers 106 but may not be getting charged or are already charged up to a predefined state of charge (SOC) level (e.g., up to 80 or 85%), one or more chargers 106 may be taped off, out of service, unavailable, blocked, broken, and/or the like.

Responsive to determining that the charging station 104 is in a suboptimal condition, the vehicle 102 may classify the suboptimal condition into a predefined type, of a plurality of predefined types, based on the inputs obtained from the vehicle sensor unit and/or the infrastructure sensors 110a, 110b. As an example, the vehicle 102 may classify the suboptimal condition into a first predefined type when all the chargers 106 may be occupied. The vehicle 102 may further classify the suboptimal condition into a second predefined type when one or more vehicles 108 may be parked in proximity to one or more chargers 106 but may not be getting charged or are already charged up to the predefined SOC level. As another example, the vehicle 102 may classify the suboptimal condition into a third predefined type when a tire associated with any vehicle 108 (e.g., the vehicle 108a) may be parked on a charging cord associated with the charger 106a (thereby increasing the probability of affecting the charging cord's operation). The vehicle 102 may further classify the suboptimal condition into a fourth predefined type when one or more chargers 106 may be taped off, out of service, unavailable, blocked, broken, and/or the like. The examples of the predefined types described above are for illustrative purpose and should not be construed as limiting. The vehicle 102 may classify the suboptimal condition into additional/different predefined types (e.g., the charging station 104 being poorly lit, presence of one or more potential malicious users in proximity to the charging station 104, etc.), based on the inputs obtained from the vehicle sensor unit and/or the infrastructure sensors 110a, 110b.

Responsive to classifying the suboptimal condition into the predefined type, the vehicle 102 may perform a remedial action based on the predefined type. For example, in some aspects, responsive to determining that the suboptimal condition may be of the first predefined type (i.e., all the chargers 106 are occupied), the vehicle 102 may recommend a different charging station to the vehicle 102 owner, so that the vehicle 102 may be driven to the different charging station. In additional or alternative aspects, responsive to determining that the suboptimal condition may be of the first predefined type, the vehicle 102 may first determine whether the suboptimal condition may also be associated with the second and/or fourth predefined types. Stated another way, responsive to determining that all the chargers 106 are occupied, the vehicle 102 may determine whether one or more vehicles 108 (e.g., the vehicle 108b) may be parked in proximity to one or more chargers 106 (the charger 106b) but may not be getting charged or is already charged up to the predefined SOC level and/or one or more chargers 106 may be taped off, out of service, unavailable, blocked, broken, and/or the like.

Responsive to determining that the vehicle 108b may be parked in proximity to the charger 106b but may not be getting charged or is already charged up to the predefined SOC level (i.e., when the suboptimal condition is associated with the second predefined type), the vehicle 102 may transmit a vehicle parking adjustment request to a user device associated with the vehicle 108b owner and/or a first error notification to a server associated with a charging station operator, a firm managing availability status of a plurality of charging stations/chargers, and/or the like. In some aspects, the vehicle 102 may transmit the vehicle parking adjustment request via vehicle-to-vehicle (V2V) communication or vehicle-to-infrastructure (V2I) communication. The vehicle 108b may autonomously unplug itself (or personnel, drivers, etc. present at the charging station 104 may unplug the vehicle 108b from the charger 106b) and auto-park to a different parking location at the charging station 104 (or outside), when the vehicle 108b owner approves the vehicle parking adjustment request. When the charger 106b gets vacant, the vehicle 102 may get charged at the charger 106b. In this manner, the vehicle 102 may autonomously perform remedial actions to get itself charged when the suboptimal condition may be associated with the second predefined type (when all the chargers 106 may be occupied, or even otherwise). In some aspects, the vehicle 102 may transmit the first error notification to the server when the vehicle 108b owner may not be reachable, or may not be responding to the vehicle parking adjustment request.

In further aspects, responsive to determining that one or more chargers 106 (e.g., the charger 106c) may be taped off, out of service, unavailable, blocked, broken, and/or the like (i.e., when the suboptimal condition is of the fourth predefined type), the vehicle 102 may transmit a second error notification to a server and/or a computing device associated with a firm managing the charging station 104. The firm managing the charging station 104 may repair the charger 106c responsive to receiving the second error notification. Further, in some aspects, the server may be associated with a firm that repairs chargers at different charging stations. In this case, the firm may deploy repair trucks/vans to repair the charger 106c and/or make the charger 106c available/accessible (e.g., remove snow, debris, etc. blocking the charger 106c or the charging parking spot associated with the charger 106c, and/or the like), responsive to receiving the second error notification. In other aspects, the server may be associated with the firm that tracks availability status of a plurality of charging stations/chargers. In this case, the firm may update its database of available chargers, responsive to receiving the second error notification (i.e., remove the charger 106c from the “available chargers” list).

In some aspects, the vehicle 102 recommend a different charging station to the vehicle 102 owner responsive to identifying that all the chargers 106 are occupied, when the issue(s) associated with the second and/or fourth predefined types described above are not resolved within a predefined time duration, or when the suboptimal optimal condition is not of the second and/or fourth predefined types. For example, the vehicle 102 may recommend a different charging station to the vehicle 102 owner responsive to identifying that all the chargers 106 are occupied and when the vehicle 102 identifies that all the vehicles 108 are getting charged at respective chargers 106 and no charger 106 is taped off, out of service, unavailable, blocked, broken, and/or the like. As another example, the vehicle 102 recommend a different charging station to the vehicle 102 owner responsive to identifying that all the chargers 106 are occupied and when the vehicle 108b owner (associated with the vehicle 108b that may be parked in proximity to the charger 106b but may not be getting charged or is already charged up to the predefined SOC level) may not be reachable or may not be responding to the vehicle parking adjustment request. As yet another example, the vehicle 102 recommend a different charging station to the vehicle 102 owner responsive to identifying that all the chargers 106 are occupied and when the charger 106c (that may be taped off, out of service, unavailable, blocked, broken, and/or the like) may not get repaired or become available/accessible within a predefined time duration (e.g., within 5-8 minutes). The vehicle 102 owner may drive the vehicle 102 to the recommend charging station, responsive to viewing/hearing the recommendation from the vehicle 102.

In other aspects, the vehicle 102 recommend a different charging station to the vehicle 102 owner responsive to identifying that all the chargers 106 are occupied, irrespective of whether the issue(s) associated with the second and/or fourth predefined types are resolved within the predefined time duration or not.

In addition, responsive to determining that the tire associated with the vehicle 108a may be parked on the charging cord associated with the charger 106a (i.e., when the suboptimal condition is of the third predefined type), the vehicle 102 may transmit a small vehicle movement request directly to the vehicle 108a (or to the vehicle 108a owner who may confirm the small vehicle movement request). Responsive to receiving the small vehicle movement request, the vehicle 108a may autonomously move by a small distance (e.g., 6-8 inches) to free-up the charging cord or move the tire away from the charging cord. In this manner, the vehicle 102 may assist in preventing any potential (future) adverse situation associated with the charging cord.

Further details associated with the vehicle 102 are described below in conjunction with FIG. 2.

The vehicles 102, 108 and/or the associated owners implement and/or perform operations, as described here in the present disclosure, in accordance with the owner manual and safety guidelines. In addition, any action taken by the owners based on the notifications/recommendations provided by the vehicle 102 should comply with all the rules specific to the location and operation of the vehicle 102 (e.g., Federal, state, country, city, etc.). The notifications/recommendations, as provided by the vehicle 102, should be treated as suggestions and only followed according to any rules specific to the location and operation of the vehicle 102.

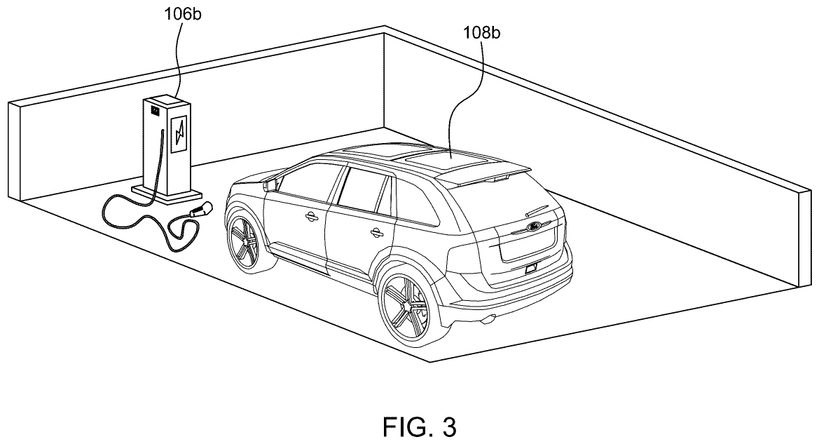

FIG. 2 depicts a block diagram of a system 200 to identify a suboptimal charging station and perform remedial actions in accordance with the present disclosure. While describing FIG. 2, references will be made to FIGS. 3, 4 and 5.

The system 200 may include the vehicle 102 and one or more servers 202 (or a server 202) communicatively coupled with each other via one or more networks 204. The server 202 may be part of a cloud-based computing infrastructure and may be associated with and/or include a Telematics Service Delivery Network (SDN) that provides digital data services to the vehicle 102 and other vehicles (not shown in FIG. 2) that may be part of a vehicle fleet. In further aspects, the server 202 may be associated with a firm that manages operation of the charging station 104. In additional aspects, the server 202 may be associated with a firm that manages/tracks availability status of each charger of a plurality of charging stations (including the charging station 104). In yet another aspect, the server 202 may be associated with a firm that repairs chargers at different charging stations. In yet another aspect, the server 202 may be configured to recommend one or more charging stations to the vehicle 102 (or to the vehicle 102 owner) on a route associated with the vehicle 102, at which the vehicle 102 may get charged. In this case, the server 202 may provide the recommendation associated with the charging stations to the vehicle 102 responsive to receiving the route details from the vehicle 102 (or from a user device associated with the vehicle 102 owner) and/or responsive to receiving a charging station recommendation request from the vehicle 102.

The network(s) 204 illustrates an example communication infrastructure in which the connected devices discussed in various embodiments of this disclosure may communicate. The network(s) 204 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 102 may include a plurality of units including, but not limited to, an automotive computer 206, a Vehicle Control Unit (VCU) 208, and a charger assessment unit 210 (or unit 210). The VCU 208 may include a plurality of Electronic Control Units (ECUs) 212 in communication with the automotive computer 206.

In some aspects, the automotive computer 206 and/or the unit 210 may be installed anywhere in the vehicle 102, in accordance with the disclosure. Further, the automotive computer 206 may operate as a functional part of the unit 210. The automotive computer 206 may be or include an electronic vehicle controller, having one or more processor(s) 214 and a memory 216. Moreover, the unit 210 may be separate from the automotive computer 206 (as shown in FIG. 2) or may be integrated as part of the automotive computer 206.

The processor(s) 214 may be in communication with one or more memory devices in communication with the respective computing systems (e.g., the memory 216 and/or one or more external databases not shown in FIG. 2). The processor(s) 214 may utilize the memory 216 to store programs in code and/or to store data for performing aspects in accordance with the disclosure. The memory 216 may be a non-transitory computer-readable medium or memory storing a charger assessment program code. The memory 216 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 208 may share a power bus with the automotive computer 206 and may be configured and/or programmed to coordinate the data between vehicle 102 systems, connected servers (e.g., the server(s) 202), and other vehicles (not shown in FIG. 2) operating as part of a vehicle fleet. The VCU 208 may include or communicate with any combination of the ECUs 212, such as a Body Control Module (BCM) 218, an Engine Control Module (ECM) 220, a Transmission Control Module (TCM) 222, a Telematics Control Unit (TCU) 224, a Driver Assistances Technologies (DAT) controller 226, etc. The VCU 208 may further include and/or communicate with a Vehicle Perception System (VPS) 228, having connectivity with and/or control of one or more vehicle sensory system(s) 230. The vehicle sensory system 230 (or sensor unit) may include one or more vehicle sensors including, but not limited to, a radio detection and ranging (radar) sensor configured for detection and localization of objects inside and outside the vehicle 102 using radio waves, sitting area buckle sensors, sitting area sensors, a light detecting and ranging (lidar) sensor, door sensors, proximity sensors, temperature sensors, wheel sensors, ambient weather sensors, vehicle internal and external cameras, one or more rain sensors, capacitive moisture sensors, etc. In some aspects, the vehicle sensory system 230 may be configured to capture inputs associated with the charging station 104, when the vehicle 102 may be located at the charging station 104 or is being driven in proximity to the charging station 104. For example, the vehicle sensory system 230 may be configured to capture one or more charging station and/or charger images, via the vehicle's interior or exterior cameras, one or more radar sensors, lidar sensors, and/or the like, when the vehicle 102 may be located at the charging station 104 or is being driven in proximity to the charging station 104.

In some aspects, the VCU 208 may control vehicle operational aspects and implement one or more instruction sets received from the user device associated with the vehicle 102 owner, from one or more instruction sets stored in the memory 216, including instructions operational as part of the unit 210.

The TCU 224 may be configured and/or programmed to provide vehicle connectivity to wireless computing systems onboard and off board the vehicle 102 and may include a Navigation (NAV) receiver 232 for receiving and processing a GPS signal, a BLE Module (BLEM) 234, a Wi-Fi transceiver, a UWB transceiver, and/or other wireless transceivers (not shown in FIG. 2) that may be configurable for wireless communication (including cellular communication) between the vehicle 102 and other systems (e.g., a key fob, not shown), computers, and modules. The TCU 224 may be in communication with the ECUs 212 by way of a bus.

The ECUs 212 may control aspects of vehicle operation and communication using inputs from human drivers, inputs from an autonomous vehicle controller, the unit 210, and/or via wireless signal inputs received via the wireless connection(s) from other connected devices, such as the user device associated with the vehicle 102 owner, the server(s) 202, among others.

The BCM 218 generally includes integration of sensors, vehicle performance indicators, and variable reactors associated with vehicle systems and may include processor-based power distribution circuitry that can control functions associated with the vehicle body such as lights, windows, security, camera(s), headlights, audio system(s), speakers, wipers, door locks and access control, and various comfort controls. The BCM 218 may also operate as a gateway for bus and network interfaces to interact with remote ECUs (not shown in FIG. 2).

The DAT controller 226 may provide Level-1 through Level-3 automated driving and driver assistance functionality that may include, for example, active parking assistance, vehicle backup assistance, and adaptive cruise control, among other features. The DAT controller 226 may also provide aspects of user and environmental inputs usable for user authentication.

In some aspects, the automotive computer 206 may connect with an infotainment system 236 (or a vehicle Human-Machine Interface (HMI)). The infotainment system 236 may include a touchscreen interface portion and may include voice recognition features, biometric identification capabilities that can identify users based on facial recognition, voice recognition, fingerprint identification, or other biological identification means. In other aspects, the infotainment system 236 may be further configured to receive user instructions/inputs via the touchscreen interface portion and/or display notifications/recommendations, navigation maps, etc. on the touchscreen interface portion.

The computing system architecture of the automotive computer 206, the VCU 208, and/or the unit 210 may omit certain computing modules. It should be readily understood that the computing environment depicted in FIG. 2 is an example of a possible implementation according to the present disclosure, and thus, it should not be considered limiting or exclusive.

In accordance with some aspects, the unit 210 may be integrated with and/or executed as part of the ECUs 212. The unit 210, regardless of whether it is integrated with the automotive computer 206 or the ECUs 212, or whether it operates as an independent computing system in the vehicle 102, may include a transceiver 238, a processor 240, and a computer-readable memory 242.

The transceiver 238 may be configured to receive information/inputs from one or more external devices or systems, e.g., the user device associated with the vehicle 102 owner, the server(s) 202, and/or the like via the network 204. For example, the transceiver 238 may receive the charging station recommendations from the server(s) 202 via the network 204. Further, the transceiver 238 may transmit notifications (e.g., alert/alarm signals) to the external devices or systems. In addition, the transceiver 238 may be configured to receive information/inputs from vehicle 102 components such as the infotainment system 236, the vehicle sensory system 230, and/or the like. Further, the transceiver 238 may transmit notifications (e.g., alert/alarm/command signals) to the vehicle 102 components such as the infotainment system 236, the BCM 218, etc.

The processor 240 and the memory 242 may be the same as or similar to the processor 214 and the memory 216, respectively. In some aspects, the processor 240 may utilize the memory 242 to store programs in code and/or to store data for performing aspects in accordance with the disclosure. The memory 242 may be a non-transitory computer-readable medium or memory storing the charger assessment program code.

In operation, the processor 240 may obtain the inputs/images from the vehicle sensory system 230 when the vehicle 102 may be traveling in proximity to the charging station 104 or located at the charging station 104. In some aspects, the images may be the charging station or charger images that the vehicle sensory system 230 may capture. In addition, the processor 240 may obtain, via the transceiver 238, additional charging station or charger images or inputs from the infrastructure sensors 110a, 110b disposed at the charging station 104 and/or the computing system/server (e.g., the server 202) associated with the charging station 104, when the vehicle 102 may be traveling in proximity to the charging station 104 or located at the charging station 104.

Responsive to obtaining the inputs described above, the processor 240 may execute image processing algorithms (that may be pre-stored in the memory 242) to determine that the charging station 104 may be in a suboptimal condition based on the obtained inputs/images (obtained from the vehicle sensory system 230, the infrastructure sensors 110a, 110b, the server 202, and/or the like). The processor 240 may further classify the suboptimal condition into a predefined type, of a plurality of predefined types, based on the obtained inputs/images. The examples of the predefined types are described above in conjunction with FIG. 1.

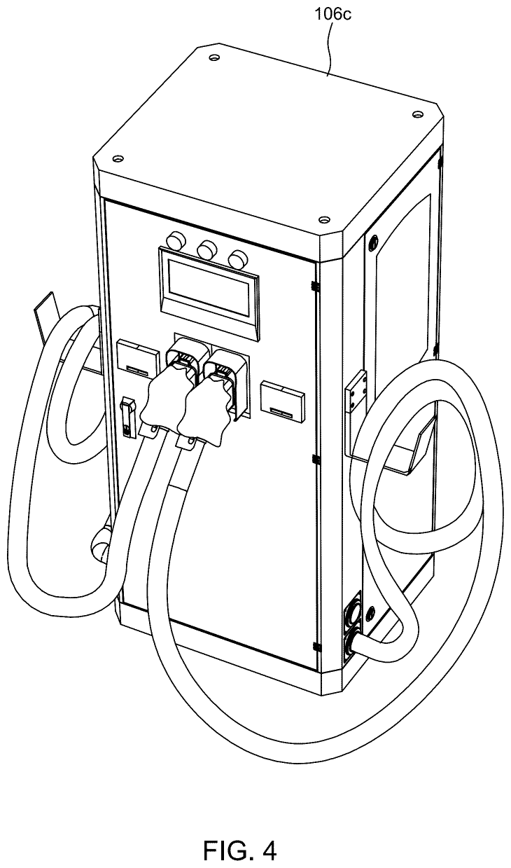

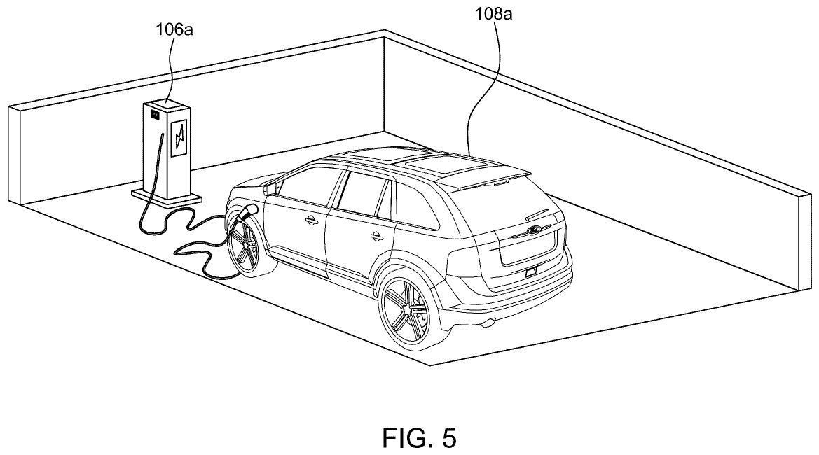

In some aspects, responsive to classifying the suboptimal condition into the predefined type, the processor 240 may output a classification confirmation request for the vehicle 102 owner on the infotainment system 236 and/or the user device associated with the vehicle 102 owner. The classification confirmation request may include information associated with the determined predefined type. For example, the classification confirmation request may include information indicating that the processor 240 has identified that all the chargers 106 are occupied (i.e., the first predefined type, as shown in FIG. 1), the vehicle 108b is parked in proximity to the charger 106b but is not getting charged (as shown in FIG. 3) or is already charged up to the predefined SOC level (i.e., the second predefined type), the tire associated with the vehicle 108a is parked on the charging cord associated with the charger 106a (i.e., the third predefined type, as shown in FIG. 5), the charger 106c is taped off, out of service, unavailable, blocked, broken, and/or the like (i.e., the fourth predefined type, as shown in FIG. 4), and/or the like.

Responsive to viewing/hearing the classification confirmation request, the vehicle 102 owner may confirm/approve the request, indicating that the vehicle 102 owner agrees with the charging station assessment performed by the processor 240. The processor 240 may obtain a confirmation from the vehicle 102 owner (e.g., via the infotainment system 236 and/or the user device), when the vehicle 102 owner confirms/approves the request.

The processor 240 may perform a remedial action based on the determined predefined type, when the processor 240 obtains the confirmation from the vehicle 102 owner. In alternative aspects, the processor 240 may perform the remedial action even without transmitting the classification confirmation request and/or obtaining the confirmation from the vehicle 102 owner. Stated another way, the step of transmitting the classification confirmation request and/or obtaining the confirmation from the vehicle 102 owner should not be construed as necessary for the present disclosure.

Examples of the remedial actions performed by the processor 240 are described below. The examples described below should not be construed as limiting, and the processor 240 may perform additional remedial actions based on the determined type of suboptimal condition associated with the charging station 104, without departing from the present disclosure scope.

In some aspects, responsive to determining that all the chargers 106 are occupied (i.e., the first predefined type), the processor 240 may determine/check whether any vehicle 108 (e.g., the vehicle 108b) is parked in proximity to the charger 106b or the parking spot associated with the charger 106b, but is not plugged-in, or plugged-in but not getting charged, or is already charged up to the predefined SOC level (i.e., the suboptimal condition is of the second predefined type, along with the first predefined type), based on the obtained images/inputs. In other aspects, the processor 240 may determine/check whether the suboptimal condition is of the second predefined type based on the obtained images/inputs, irrespective of whether the suboptimal condition is of the first predefined type or not.

Responsive to determining that the vehicle 108b is parked in proximity to the charger 106b but is not plugged-in, the processor 240 may transmit, via the transceiver 238, a vehicle parking adjustment request to a user device associated with the vehicle 108b owner, requesting the vehicle 108b owner to cause and/or authorize autonomous movement or auto-park of the vehicle 108b to another parking location at the charging station 104. The vehicle 108b may autonomously move and park itself to a different parking location, when the vehicle 108b owner confirms/approves the vehicle parking adjustment request. When the vehicle 108b moves and the charger 106b gets vacant, the vehicle 102 may get charged at the charger 106b. In this manner, the vehicle 102 enables convenient and efficient vehicle charging.

On the other hand, responsive to determining that the user device associated with the vehicle 108b owner is not reachable or the vehicle 108b owner is not responding to the vehicle parking adjustment request, the processor 240 may transmit, via the transceiver 238, a first error notification to the server 202 or the computing device associated with the firm that manages the charging station 104 operation, indicating that the vehicle 108b is obstructing access to the charger 106b. In this case, the charging station operator may take appropriate actions to make the charger 106b available/accessible.

In further aspects, responsive to determining that the vehicle 108b is parked in proximity to the charger 106b and is plugged-in, but not getting charged or already charged up to the predefined SOC level, the processor 240 may transmit, via the transceiver 238, a vehicle un-plug request and the vehicle parking adjustment request to the user device associated with the vehicle 108b owner, requesting the vehicle 108b owner to authorize un-plugging of the vehicle 108b from the charger 106b and autonomous movement or auto-park of the vehicle 108b to another parking location at the charging station 104. The vehicle 108b may autonomously un-plug itself, move and park itself to a different parking location, when the vehicle 108b owner confirms/approves the vehicle un-plug request and the vehicle parking adjustment request. In some aspects, when the vehicle 108b may not be configured to autonomously un-plug itself, the user device associated with the vehicle 108b owner or the vehicle 108b may transmit a signal to the server 202, and the server 202 may notify one or more drivers, personnel, etc. located at the charging station 104 to manually unplug the vehicle 108b responsive to obtaining the signal from the user device associated with the vehicle 108b owner or the vehicle 108b. When the vehicle 108b gets unplugged and moves to a different parking location, the vehicle 102 may charge at the charger 106b, as described above.

In some aspects, responsive to determining that the suboptimal condition is of the first predefined type but not of the second predefined type as described above, the processor 240 may determine whether any charger (e.g., the charger 106c) at the charging station 104 is not operational or accessible (i.e., the suboptimal condition is of the fourth predefined type, along with the first predefined type), based on the obtained images/inputs. For example, the processor 240 may determine if the charger 106c is taped off, out of service, unavailable, blocked (e.g., due to snow, debris), broken, and/or the like. In alternative aspects, the processor 240 may determine whether the suboptimal condition is of the fourth predefined type based on the obtained images/inputs, irrespective of whether the suboptimal condition is of the first and/or second predefined types or not.

Responsive to determining that the charger 106c may not be operational or accessible, the processor 240 may determine an identifier information (e.g., charger's relative/exact position in the charging station 104, charger ID/name, etc.) and an issue type associated with the charger 106c, based on the obtained images/inputs. The issue type may be, for example, whether the charger 106c is taped off (as shown in FIG. 4), inaccessible due to snow, debris, etc. in front of the charger 106c, broken/out of service, and/or the like. The processor 240 may further output an issue type confirmation request on the infotainment system 236 and/or the user device associated with the vehicle 102 owner, responsive to determining the identifier information and the issue type associated with the charger 106c. In some aspects, the issue type confirmation request may include information associated with the determined issue type. The vehicle 102 owner may view/hear the issue type confirmation request and may approve/confirm the request if the vehicle 102 owner agrees with the issue type determined by the processor 240. The processor 240 may obtain a confirmation from the vehicle 102 owner, via the user device or the infotainment system 236, when the vehicle 102 owner approves/confirms the request.

Responsive to obtaining the confirmation, the processor 240 may transmit, via the transceiver 238, a second error notification to the server 202 or a computing system associated with the firm that manages the charging station 104 operation. In some aspects, the second error notification may include the identifier information and the information associated with the determined issue type.

When the server 202 is associated with the firm that repairs chargers at charging stations or the firm that manages the charging station 104 operation, the firm may check/determine whether the issue associated with the charger 106c is quickly fixable/actionable, based on the second error notification. As an example, the firm may determine that the issue may be fixable when snow/debris may be blocking the charger 106c. Responsive to such determination, the firm may deploy a service van and/or personnel to clear the snow/debris and then the vehicle 102 may charge at the charger 106c. On the other hand, responsive to determining that the issue is not quickly fixable/actionable, the firm may order repair parts for the charger 106c and/or post “Out of order” message on the charger 106c. Further, in this case, the firm that manages availability status of each charger of a plurality of charging stations (including the charging station 108) may mark the charger 106c as “unavailable” in its database (so that other vehicles obtaining charging station recommendations from the server 202 may know that the charger 106c is not available/under repair).

In further aspects, responsive to determining that all the chargers 106 are occupied (i.e., when the suboptimal condition is of the first predefined type) and the suboptimal condition is not of the second or fourth predefined types or the issues associated with the second or fourth predefined types are not quickly fixable/actionable, the processor 240 may transmit, via the transceiver 238, a request to the server 202 to obtain a recommendation for a different charging station in the vehicle 102 route. Stated another way, when the processor 240 is not able to identify or “make available” an accessible charger 106 for the vehicle 102 at which the vehicle 102 may get charged at the charging station 104, the processor 240 may transmit the request to the server 202. Responsive to receiving the request from the processor 240, the server 202 may transmit information associated with a recommended alternative charging station to the processor 240.

The processor 240 may then output, via the infotainment system 236 and/or the user device associated with the vehicle 102 owner, the information associated with the recommended alternative/different charging station for the vehicle 102 owner. In some aspects, the information may include navigation instructions, using which the vehicle 102 owner may drive the vehicle 102 from the charging station 104 to the recommended alternative charging station. In this manner, the vehicle 102 may enable the vehicle 102 owner to conveniently identify another charging station at which the vehicle 102 may get charged and may enable the vehicle 102 owner to navigate to the other charging station. In further aspects, the processor 240 may output information associated with one or more incentives/rewards that may be offered to the vehicle 102 owner at the other charging station, e.g., discounts on charging rates, free food/coffee, etc.

In further aspects, the processor 240 may use generative Artificial Intelligence (AI) to generate a charging station review text associated with the charging station 104 based on the images/inputs obtained from the vehicle sensory system 230 and/or the infrastructure sensors 110a, 110b, known user preferences (that may be pre-stored in the memory 242), the issues determined at the charging station 104 and remedial actions performed (if any), date and time of vehicle 102's visit to the charging station 104, and/or the like. The processor 240 may then output a review confirmation request on the infotainment system 236 and/or the user device associated with the vehicle 102 owner, responsive to generating the charging station review text. In some aspects, the review confirmation request may include the charging station review text generated by the processor 240.

The vehicle 102 owner may view/hear the review confirmation request and may read the charging station review text. If the vehicle 102 owner agrees with the charging station review text, the vehicle 102 owner may approve/confirm the review confirmation request on the infotainment system 236 or the user device associated with the vehicle 102 owner. When the vehicle 102 owner approves the request, the processor 240 may obtain a confirmation from the vehicle 102 owner via the infotainment system 236 or the user device associated with the vehicle 102 owner. Responsive to obtaining the confirmation, the processor 240 may transmit, via the transceiver 238, the charging station review text to the server 202, which may publish the charging station review text so that other vehicle drivers/owners may view/access the charging station review text.

In additional aspects, irrespective of whether the suboptimal condition is of the first, second and/or fourth predefined types or not, the processor 240 may determine whether a tire associated with any vehicle (e.g., the vehicle 108a) may be parked on a charging cord associated with any charger 106 (e.g., the charger 106a), based on the images/inputs obtained from the vehicle sensory system 230 and/or the infrastructure sensors 110a, 110b. Stated another way, irrespective of whether the suboptimal condition is of the first, second and/or fourth predefined types or not, the processor 240 may determine whether the suboptimal condition may be of the third predefined type.

Responsive to determining that the tire associated with the vehicle 108a may be parked on the charging cord associated with the charger 106a (as shown in FIG. 5), the processor 240 may transmit, via the transceiver 238, a small vehicle movement request directly to the vehicle 108a or a user device associated with the vehicle 108a owner. The vehicle 108a owner may view/hear the small vehicle movement request and approve the request, at which time, the vehicle 108a may autonomously move slightly (e.g., 6-8 inches), thereby causing the tire to move away from the charging cord. In this manner, the vehicle 102 may prevent any adverse situation associated with the charging cord.

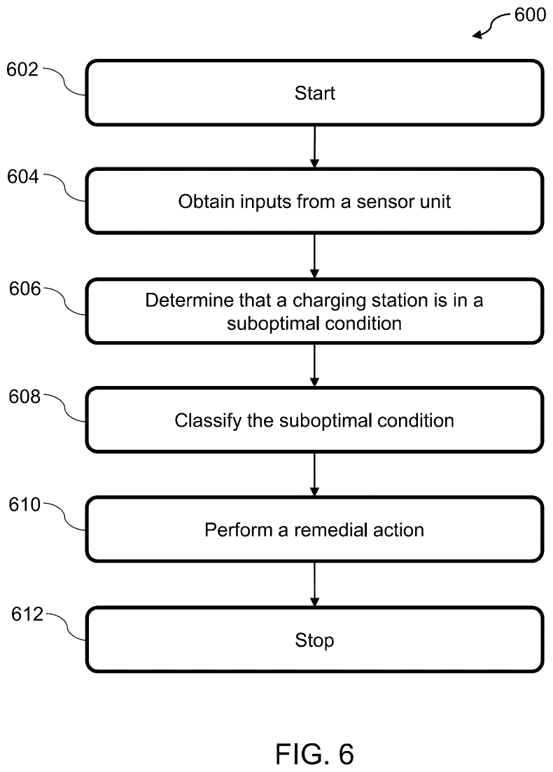

FIG. 6 depicts a flow diagram of a method 600 to identify a suboptimal charging station and perform remedial actions in accordance with the present disclosure. FIG. 6 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 600 starts at step 602. At step 604, the method 600 may include obtaining, by the processor 240, inputs from the vehicle sensory system 230. At step 606, the method 600 may include determining, by the processor 240, that the charging station 104 may be in a suboptimal condition based on the obtained inputs. At step 608, the method 600 may include classifying, by the processor 240, the suboptimal condition into a predefined type, of the plurality of predefined types, based on the obtained inputs, as described above in conjunction with FIGS. 1 and 2. At step 610, the method 600 may include performing, by the processor 240, a remedial action based on the predefined type.

The method 600 may end at step 612.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A first vehicle comprising:
a sensor unit configured to capture inputs associated with a charging station when the first vehicle is located at the charging station; and
a processor communicatively coupled with the sensor unit, wherein the processor is configured to:
obtain the inputs from the sensor unit;
determine that the charging station is in a suboptimal condition based on the inputs;
classify the suboptimal condition into a predefined type, of a plurality of predefined types, based on the inputs; and
perform a remedial action based on the predefined type.

2. The first vehicle of claim 1, wherein the processor is further configured to:
output a classification confirmation request responsive to classifying the suboptimal condition, wherein the classification confirmation request comprises information associated with the predefined type;
obtain a confirmation from a user responsive to outputting the classification confirmation request; and
perform the remedial action responsive to obtaining the confirmation.

3. The first vehicle of claim 1, wherein the processor is further configured to:
generate a charging station review based on the inputs;
output a review confirmation request responsive to generating the charging station review, wherein the review confirmation request comprises the charging station review;
obtain a confirmation from a user responsive to outputting the review confirmation request; and
perform the remedial action responsive to obtaining the confirmation, wherein the remedial action comprises transmitting the charging station review to a server.

4. The first vehicle of claim 1, wherein the predefined type is a first predefined type when the processor determines that all chargers at the charging station are occupied.

5. The first vehicle of claim 4, wherein the processor is further configured to:
determine that a charger at the charging station is occupied by a second vehicle that is not getting charged at the charger or is charged to a predefined state of charge (SOC) level when the predefined type is the first predefined type, and
wherein the processor performs the remedial action by transmitting a vehicle parking adjustment request to a user device associated with an owner of the second vehicle or an error notification to a server responsive to determining that the charger is occupied by the second vehicle.

6. The first vehicle of claim 5, wherein the second vehicle is configured to autonomously move and park at a different location in the charging station when the owner of the second vehicle confirms the vehicle parking adjustment request.

7. The first vehicle of claim 4, wherein the processor performs the remedial action by outputting a recommendation for a different charging station in a route of the first vehicle when the predefined type is the first predefined type.

8. The first vehicle of claim 7, wherein the processor is further configured to output information associated with one or more incentives for an owner associated with the first vehicle when the predefined type is the first predefined type.

9. The first vehicle of claim 1, wherein the predefined type is a second predefined type when the processor determines that a tire associated with a third vehicle is parked on a charging cord of a charger at the charging station, and wherein the processor performs the remedial action by transmitting a small vehicle movement request to the third vehicle or a user device associated with an owner of the third vehicle when the predefined type is the second predefined type.

10. The first vehicle of claim 1, wherein the predefined type is a third predefined type when the processor determines that at least one charger at the charging station is not operational, and wherein the processor performs the remedial action by transmitting an error notification to a server or a computing system associated with the charging station when the predefined type is the third predefined type.

11. The first vehicle of claim 10, wherein the processor is further configured to:
determine an identifier information and an issue type associated with the at least one charger based on the inputs;
output an issue type confirmation request, wherein the issue type confirmation request comprises information associated with the issue type;
obtain a confirmation from a user responsive to outputting the issue type confirmation request; and
transmit the error notification responsive to obtaining the confirmation, wherein the error notification comprises the identifier information and the information associated with the issue type.

12. The first vehicle of claim 1, wherein the sensor unit comprises at least one of a vehicle camera, a Radio Detection and Ranging (radar) sensor, or a Light Detection and Ranging (lidar) sensor.

13. The first vehicle of claim 1, wherein the processor is further configured to:
obtain additional inputs from one or more sensors associated with the charging station; and
determine that the charging station is in the suboptimal condition and classify the suboptimal condition into the predefined type based on the additional inputs.

14. A method comprising:
obtaining, by a processor, inputs from a sensor unit associated with a first vehicle, wherein the sensor unit is configured to capture the inputs associated with a charging station when the first vehicle is located at the charging station;
determining, by the processor, that the charging station is in a suboptimal condition based on the inputs;
classifying, by the processor, the suboptimal condition into a predefined type, of a plurality of predefined types, based on the inputs; and
performing, by the processor, a remedial action based on the predefined type.

15. The method of claim 14 further comprising:
outputting a classification confirmation request responsive to classifying the suboptimal condition, wherein the classification confirmation request comprises information associated with the predefined type;
obtaining a confirmation from a user responsive to outputting the classification confirmation request; and
performing the remedial action responsive to obtaining the confirmation.

16. The method of claim 14 further comprising:
generating a charging station review based on the inputs;
outputting a review confirmation request responsive to generating the charging station review, wherein the review confirmation request comprises the charging station review;
obtaining a confirmation from a user responsive to outputting the review confirmation request; and
performing the remedial action responsive to obtaining the confirmation, wherein the remedial action comprises transmitting the charging station review to a server.

17. The method of claim 14, wherein the predefined type is a first predefined type when all chargers at the charging station are occupied, and wherein performing the remedial action comprises outputting a recommendation for a different charging station in a route of the first vehicle when the predefined type is the first predefined type.

18. The method of claim 14, wherein the predefined type is a second predefined type when a tire associated with a second vehicle is parked on a charging cord of a charger at the charging station, and wherein performing the remedial action comprises transmitting a small vehicle movement request to the second vehicle or a user device associated with an owner of the second vehicle when the predefined type is the second predefined type.

19. The method of claim 14, wherein the predefined type is a third predefined type when at least one charger at the charging station is not operational, and wherein performing the remedial action comprises transmitting an error notification to a server or a computing system associated with the charging station when the predefined type is the third predefined type.

20. A non-transitory computer-readable storage medium having instructions stored thereupon which, when executed by a processor, cause the processor to:
obtain inputs from a sensor unit associated with a vehicle, wherein the sensor unit is configured to capture the inputs associated with a charging station when the vehicle is located at the charging station;
determine that the charging station is in a suboptimal condition based on the inputs;
classify the suboptimal condition into a predefined type, of a plurality of predefined types, based on the inputs; and
perform a remedial action based on the predefined type.
